(19) United States
(12) Patent Application Publication
(10) Pub. No.: US 2026/0147208 A1
(43) Pub. Date: May 28, 2026

(54) WAVEGUIDE WITH OVERLAPPING REFLECTIVE FACETS

(71) Applicant: GOOGLE LLC, Mountain View, CA (US)

(72) Inventors: Daniel Adema, Kitchener (CA); Timothy Paul Bodiya, Toronto (CA)

(21) Appl. No.: 19/120,819

(22) PCT Filed: Oct. 11, 2023
(86) PCT No.: PCT/US2023/076545

§ 371 Date: Apr. 14, 2025

Related U.S. Application Data
(60) Provisional application No. 63/416,062, filed on Oct. 14, 2022.

(51) Int. Cl. G02B 27/01; G02B 6/26

(52) U.S. Cl. CPC G02B 27/0172; G02B 6/26; G02B 2027/0123

(57) ABSTRACT

A waveguide includes an outcoupler that is implemented in the waveguide as a set of reflective facets that is arranged along a first direction. Each reflective facet is made by applying a reflective coating to a planar face of one or more substrates. Adjacent reflective facets in the set of reflective facets overlap one another along the first direction. For example, a leading portion of one reflective facet in the set of reflective facets overlaps with a tailing portion of the reflective facet adjacent to it.

### BACKGROUND

In an eyewear display, display light beams from a light engine are initially coupled into a waveguide by an incoupler which can be formed on a surface, or multiple surfaces, of the waveguide or disposed within the waveguide. Once the display light beams have been coupled into the waveguide, the incoupled display light beams are “guided” through the waveguide, typically by multiple instances of total internal reflection (TIR), to then be directed out of the waveguide by an outcoupler, which can also be formed on or within the waveguide. The outcoupled display light beams overlap at an eye relief distance from the waveguide forming an exit pupil within which a virtual image generated by the light engine can be viewed by the user of the eyewear display. The waveguide can also include an exit pupil expander positioned between the incoupler and the outcoupler to increase the size of the exit pupil within which the user can view the virtual image.

In some cases, one or more of the incoupler, exit pupil expander, and the outcoupler are implemented in the waveguide as a set of reflective facets. Conventional waveguides with reflective facets are often susceptible to diminished optical performance due to discontinuities in the virtual image that is delivered to the user.

### SUMMARY

Various embodiments include a waveguide with overlapping reflective facets that reduce or eliminate discontinuities in the virtual image delivered to the user of an eyewear display.

In a first embodiment, a waveguide includes a plurality of reflective facets that are arranged along a first direction in the waveguide. For example, the plurality of reflective facets is arranged in a linear series to realize an outcoupler of the waveguide. Adjacent reflective facets of the plurality of reflective facets overlap one another along the first direction.

In some aspects of the first embodiment, the waveguide includes two substrates. A first substrate of the two substrates includes a first plurality of planar faces, and a second substrate of the two substrates includes a second plurality of planar faces. In some aspects, the first plurality of planar faces and the second plurality of planar faces are at least partially coated (or fully coated) with a reflective coating, such as a metallic layer coating or a dichroic layer coating. The first plurality of planar faces coated with the reflective coating is positioned to contact the second plurality of planar faces coated with the reflective coating. In this manner, each of the plurality of reflective facets are formed at an interface between the first plurality of planar faces with the reflective coating and the second plurality of planar faces with the reflective coating. In some cases, the waveguide includes a gap between the first substrate and the second substrate, and the gap is filled with an adhesive material to adhere the first substrate to the second substrate. The adhesive material has a refractive index corresponding to a refractive index of a material of the first substrate and the second substrate. For example, the refractive index of the adhesive material is matched to the refractive index of the material of the first substrate and the second substrate.

In some aspects of the first embodiment, the waveguide includes a second plurality of reflective facets arranged in series along the first direction in the waveguide. The second plurality of reflective facets are adjacent to the plurality of reflective facets, and adjacent reflective facets of the second plurality of reflective facets overlap one another along the first direction. In some aspects, the waveguide includes a third substrate and a fourth substrate. The third substrate includes a third plurality of planar faces, and the fourth substrate includes a fourth plurality of planar faces. In some aspects, the third plurality of planar faces and the fourth plurality of planar faces are at least partially coated (or fully coated) with a second reflective coating. In some cases, the second reflective coating is different than the reflective coating on the first plurality of planar faces and on the second plurality of planar faces. In some aspects, the third plurality of planar faces coated with the second reflective coating is positioned to contact the fourth plurality of planar faces coated with the second reflective coating. In this manner, each of the second plurality of reflective facets are formed at an interface between the third plurality of planar faces with the second reflective coating and the fourth plurality of planar faces with the second reflective coating. In some aspects, there is a gap between the third substrate and the fourth substrate, and this gap is filled with an adhesive material to adhere the third substrate to the fourth substrate. In some cases, the adhesive material includes a refractive index corresponding to a refractive index of a material of the third substrate and the fourth substrate. In some aspects, the adhesive material to adhere the third substrate to the fourth substrate is a same material as the adhesive material to adhere the first substrate to the second substrate. Additionally, in some cases, there is an additional layer of adhesive material that adheres the first substrate or the second substrate to the third substrate or the fourth substrate.

In a second embodiment, a waveguide includes a first plurality of reflective facets and a second plurality of reflective facets. The first plurality of reflective facets is arranged along a first direction in the waveguide, and adjacent reflective facets of the first plurality of reflective facets overlap one another along the first direction. The second plurality of reflective facets is arranged along the first direction in the waveguide, and adjacent reflective facets of the second plurality of reflective facets overlap one another along the first direction.

In some aspects of the second embodiment, the first plurality of reflective facets is configured to reflect a first wavelength range of light and transmit a second wavelength range of light. In some aspects, the second plurality of reflective facets is configured to reflect the second wavelength range of light, and light reflected from the second plurality of reflective facets passes through the first plurality of reflective facets.

In a third embodiment, a method includes reflecting, via a first reflective facet in a plurality of reflective facets at an outcoupler of a waveguide, light in an outcoupling direction, and reflecting, via a second reflective facet in the plurality of reflective facets at the outcoupler, light in the outcoupling direction, where a portion of the light reflected from the second reflective facet coincides with a portion of the light reflected from the first reflective facet. In some aspects of the third embodiment, the plurality of reflective facets is arranged in a series along a first direction in the waveguide, and adjacent reflective facets of the plurality of reflective facets overlap one another along the first direction.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example eyewear display in accordance with some embodiments.

FIG. 2 shows an example of a projection system with a light filter arranged between the light engine and an incoupler of a waveguide of an eyewear display, such as that shown in FIG. 1, in accordance with some embodiments.

FIG. 3 shows a plan view illustrating an example of the propagation of light within the waveguide of the projection system of FIG. 2, in accordance with some embodiments.

FIG. 4 shows an example of a conventional reflective facet configuration and problems associated with such a configuration.

FIG. 5 shows an example of a set of overlapping reflective facets to be implemented at one or more of an incoupler, at an exit pupil expander, or at an outcoupler in a waveguide, in accordance with various embodiments.

FIGS. 6-8 show examples of alternative embodiments of sets of overlapping reflective facets to be implemented at one or more of an incoupler, at an exit pupil expander, or at an outcoupler in a waveguide, in accordance with various embodiments.

FIG. 9 shows an example of a stack of multiple sets of overlapping reflective facets in accordance with some embodiments.

FIG. 10 shows a method flowchart for reflecting light via overlapping reflective facets in accordance with some embodiments.

### DETAILED DESCRIPTION

A reflective facet waveguide includes one or more sets of reflective facets to implement one or more of the incoupler, outcoupler, or exit pupil expander. Utilizing an outcoupler as an example, the outcoupler is realized as a set of reflective facets that receives light from the exit pupil expander and reflects the light out of the waveguide to the user. Typically, the set of reflective facets is made by applying a reflective coating to a series of planar faces on a molded plastic or polymer substrate. Ideally, each reflective facet has sharp corners at both edges and there is no gap between adjacent reflective facets. However, in reality, conventional molded plastic substrates have planar faces with rounded edges as well as draft angles (i.e., non-perpendicular angles) between the planar faces due to molding process limitations. These rounded edges and draft angles result in gaps between adjacent conventional reflective facets that are applied to the planar faces. The gaps between adjacent conventional reflective facets generate gaps in the outcoupled light, which in turn produce discontinuities in the virtual image delivered to the user. For example, if the virtual image is supposed to be a straight line, the gaps in the outcoupled light produce “blips” in the line that is perceived by the user. Described herein are waveguides with overlapping reflective facets that eliminate the aforementioned gaps in the light that is outcoupled to the user, thereby reducing or eliminating the discontinuities in the virtual image that is perceived by the user. This improves the optical performance of the waveguide and an eyewear display incorporating such a waveguide.

To illustrate, in some embodiments, a waveguide includes optical components such an incoupler, an exit pupil expander, and an outcoupler. One or more of these optical components is implemented in the waveguide as a set of reflective facets that is arranged along a first direction, i.e., the reflective facets in the set are arranged in a series along a common direction. In some embodiments, each reflective facet is made by applying a reflective coating to a planar face of one or more substrates. Adjacent reflective facets in the set of reflective facets overlap one another along the first direction. For example, a leading portion (also referred to as a “tip”) of one reflective facet in the set of reflective facets overlaps with a tailing portion (also referred to as a “root”) of the reflective facet adjacent to it. In this manner, the set of reflective facets eliminates gaps that may result from rounded edges and draft angles of the one or more substrates. This decreases discontinuities in the light beams outcoupled by the waveguide, thereby improving the quality of the image generated by the outcoupled light beams.

To further illustrate, in another embodiment, one or more of the incoupler, an exit pupil expander, and an outcoupler are each implemented as two sets of reflective facets. The first set of reflective facets is arranged in series along a first axis and the second set of reflective facets is arranged in series along a second axis, where the first axis is parallel to the second axis. The reflective facets of the first set are offset from the reflective facets of the second set such that the reflective facets of the first set overlap the reflective facets of the second set when viewed from a perspective orthogonal to the first or second axis. In this manner, the light reflected off of the two sets of reflective facets overlaps, thereby minimizing or eliminating any discontinuities in the light that is outcoupled to the user.

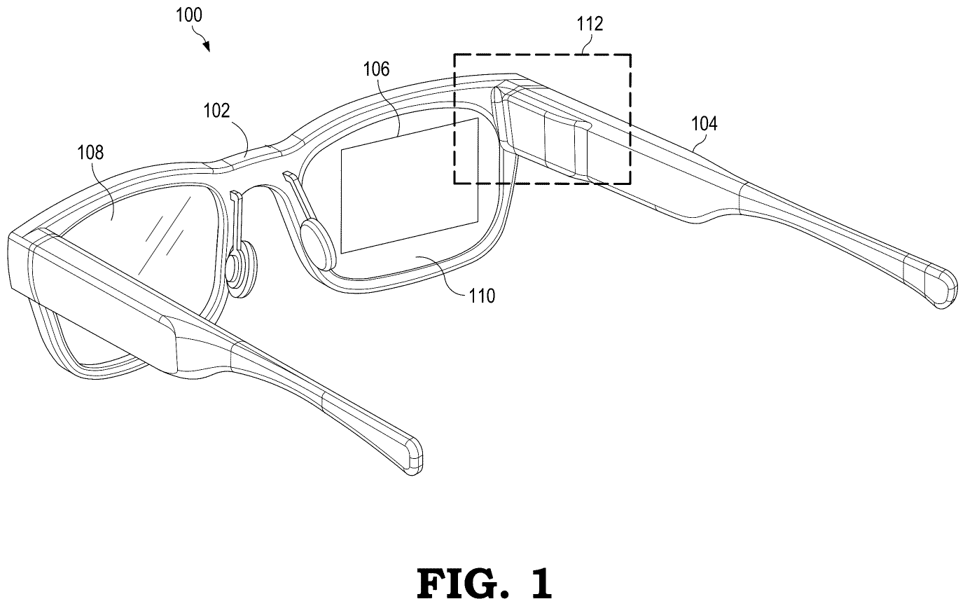

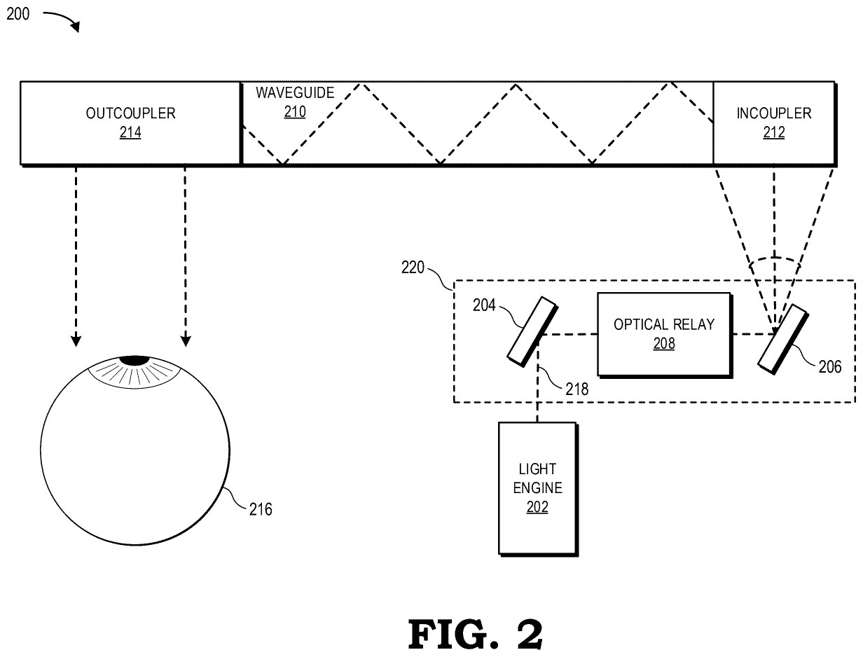

FIG. 1 illustrates an example eyewear display 100 in accordance with various embodiments. The eyewear display 100 (also referred to as a wearable heads up display (WHUD), head-mounted display (HMD), near-eye display, or the like) has a support structure 102 that includes an arm 104, which houses a micro-display projection system configured to project images toward the eye of a user, such that the user perceives the projected images as being displayed in a field of view (FOV) area 106 of a display at one or both of lens elements 108, 110. In the depicted embodiment, the support structure 102 of the eyewear display 100 is configured to be worn on the head of a user and has a general shape and appearance (i.e., “form factor”) of an eyeglasses frame. The support structure 102 contains or otherwise includes various components to facilitate the projection of such images toward the eye of the user, such as a light engine and a waveguide (shown in FIG. 2, for example). In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 includes one or more batteries or other portable power sources for supplying power to the electrical components of the eyewear display 100. In some embodiments, some or all of these components of the eyewear display 100 are fully or partially contained within an inner volume of support structure 102, such as within the arm 104 in region 112 of the support structure 102. It should be noted that while an example form factor is depicted, it will be appreciated that in other embodiments the eyewear display 100 may have a different shape and appearance from the eyeglasses frame depicted in FIG. 1.

One or both of the lens elements 108, 110 are used by the eyewear display 100 to provide an augmented reality (AR) or mixed reality (MR) display in which rendered graphical content can be superimposed over or otherwise provided in conjunction with a real-world view as perceived by the user through the lens elements 108, 110. In some embodiments, one or both of lens elements 108, 110 serve as optical combiners that combine environmental light (also referred to as ambient light) from outside of the eyewear display 100 and light emitted from a light engine in the eyewear display 100. For example, light used to form a perceptible image or series of images may be projected by the light engine of the eyewear display 100 onto the eye of the user via a series of optical elements, such as a waveguide formed at least partially in the corresponding lens element, one or more scan mirrors, one or more optical relays, and/or one or more prisms. One or both of the lens elements 108, 110 thus includes at least a portion of a waveguide that routes display light received by the incoupler of the waveguide to an outcoupler of the waveguide, which outputs the display light toward an eye of a user of the eyewear display 100. The display light is modulated and projected onto the eye of the user such that the user perceives the display light as an image in FOV area 106. In addition, in some embodiments, each of the lens elements 108, 110 is sufficiently transparent to allow a user to see through the lens elements to provide a field of view of the user's real-world environment such that the image appears superimposed over at least a portion of the real-world environment.

In some embodiments, the light engine is a matrix-based projector, a scanning laser projector, or any combination of a modulative light source such as a laser or one or more LEDs and a dynamic reflector mechanism such as one or more dynamic scanners or digital light processors. In some embodiments, the light engine includes multiple laser diodes (e.g., a red laser diode, a green laser diode, and/or a blue laser diode) and at least one scan mirror (e.g., two one-dimensional scan mirrors, which is a micro-electromechanical system (MEMS)-based or piezo-based), for example. The light engine is communicatively coupled to a controller and a non-transitory processor-readable storage medium or memory storing processor-executable instructions and other data that, when executed by the controller, cause the controller to control the operation of the projector. In some embodiments, the controller controls a scan area size and scan area location for the light engine and is communicatively coupled to a processor (not shown) that generates content to be displayed at the eyewear display 100. The light engine scans light over a variable area, designated the FOV area 106, of the display system 100. The scan area size corresponds to the size of the FOV area 106, and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the eyewear display 100.

As previously mentioned, a waveguide is integrated into one or both of lens elements 108, 110. In some configurations, the waveguide includes a single waveguide substrate and in other configurations, the waveguide includes multiple waveguide substrates stacked on top of one another (referred to as a waveguide stack). The waveguide, in some cases, includes one or more of an incoupler to incouple light from the light engine into the waveguide, an exit pupil expander to expand the incoupled light within the waveguide in one dimension, and an outcoupler to outcouple the display light to the eyebox of the eyewear display 100. In some cases, one or more of the incoupler, the exit pupil expander, and the outcoupler are implemented in the waveguide as a corresponding set of reflective facets. For example, the outcoupler is made of a set of reflective facets that receive light from the exit pupil expander and redirect the light out of the waveguide to the user via FOV area 106. In some embodiments, the reflective facets overlap with one another to minimize or eliminate gaps in the light that is outcoupled to the user. This reduces visual artifacts in the virtual image delivered to the user, thereby improving the optical performance of the eyewear display 100.

FIG. 2 illustrates a diagram of a projection system 200 that projects images onto the eye 216 of a user in accordance with various embodiments. The projection system 200, which may be implemented in the eyewear display 100 in FIG. 1, includes one or more of a light engine 202, an optical scanner 220, and/or a waveguide 210. In this example, the optical scanner 220 includes a first scan mirror 204, a second scan mirror 206, and an optical relay 208. The waveguide 210 includes one or more incouplers 212 and one or more outcouplers 214, with the one or more outcouplers 214 being optically aligned with an eye 216 of a user. For example, the one or more outcouplers 214 substantially overlaps with the FOV area 106 shown in FIG. 1.

The light engine 202 includes one or more light sources configured to generate and output light 218 (e.g., visible light such as red, blue, and green laser light and/or non-visible laser light such as infrared laser light). In some embodiments, the light engine 202 is coupled to a controller or driver (not shown), which controls the timing of emission of light from the light sources of the light engine 202 (e.g., in accordance with instructions received by the controller or driver from a computer processor coupled thereto) to modulate the light 218 to be perceived as images when output to the retina of the eye 216 of the user. For example, during operation of the projection system 200, one or more beams of display light 218 are output by the light source(s) of the light engine 202 and then directed into the waveguide 210 before being directed to the eye 216 of the user. The light engine 202 modulates the respective intensities of the light beams so that the combined light reflects a series of pixels of an image, with the particular intensity of each light beam at any given point in time contributing to the amount of corresponding color content and brightness in the pixel being represented by the combined light at that time.

In some embodiments, the optical scanner 220 includes a first scan mirror 204, a second scan mirror 206, and an optical relay 208. One or both of the scan mirrors 204 and 206 are MEMS mirrors, in some embodiments. For example, the scan mirror 204 and the scan mirror 206 are MEMS mirrors that are driven by respective actuation voltages to oscillate during active operation of the laser projection system 200, causing the scan mirrors 204 and 206 to scan the laser light 218. Oscillation of the scan mirror 204 causes light 218 output by the optical engine 202 to be scanned through the optical relay 208 and across a surface of the second scan mirror 206. The second scan mirror 206 scans the light 218 received from the scan mirror 204 toward an incoupler 212 of the waveguide 210.

The waveguide 210 of the projection system 200 includes an incoupler 212 and an outcoupler 214. The term “waveguide,” as used herein, will be understood to mean a combiner using total internal reflection (TIR), or via a combination of TIR, specialized filters, and/or reflective surfaces, to transfer light from an incoupler to an outcoupler. For display applications, the light is representative of a collimated image, for example, and the waveguide transfers and replicates the collimated image to the eye. In general, the terms “incoupler” and “outcoupler” will be understood to refer to any type of optical grating structure, including, but not limited to, a set of reflective facets, diffraction gratings, slanted gratings, blazed gratings, holograms, holographic optical elements (e.g., optical elements using one or more holograms), volume diffraction gratings, volume holograms, surface relief diffraction gratings, and/or surface relief holograms. In some embodiments, one or more of the incoupler 212, an exit pupil expander (not shown in FIG. 2), and the outcoupler 214 are implemented in the waveguide 210 by a corresponding set of reflective facets. In the present example, the light 218 received at the incoupler 212 is propagated to the outcoupler 214 via the waveguide 210 using TIR. The laser light 218 is then output to the eye 216 of a user via the outcoupler 214.

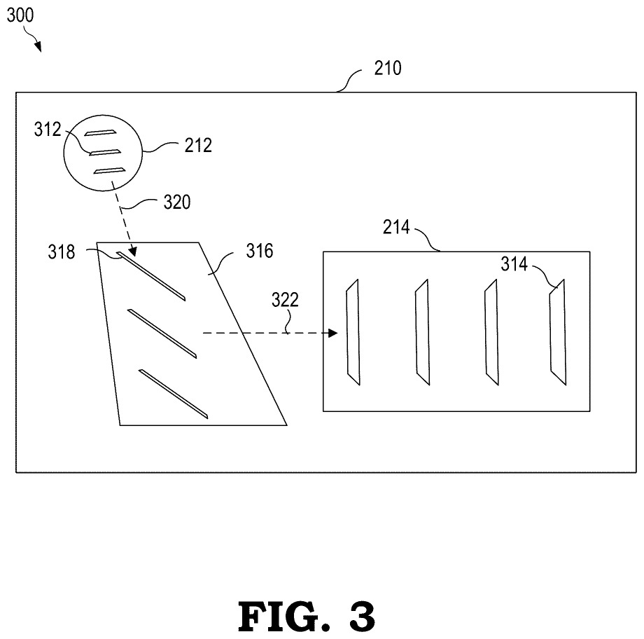

FIG. 3 shows a plan view of an example of light propagation within the waveguide 210 of the projection system 200 of FIG. 2. As shown, light is received via incoupler 212, directed as light 320 into an exit pupil expander (EPE) 316, and then routed as light 322 to the outcoupler 214 to be output from the waveguide 212 toward the eye of the user (e.g., the light is reflected by the outcoupler 214 in a direction out of the page). In some embodiments, the exit pupil expander 316 expands one or more dimensions of the eyebox of an eyewear display that includes the laser projection system 200 (e.g., with respect to what the dimensions of the eyebox of the eyewear display would be without the exit pupil expander 316). In some embodiments, at least one of the incoupler 212, the exit pupil expander 316, and the outcoupler 214 each include a set of reflective facets. For example, at the incoupler 212, a first set of reflective facets 312 (one labeled for clarity) receives light from emitted from the light engine (such as from light engine 202 in FIG. 2, not shown in FIG. 3) and reflects the light such that the light 320 is incoupled into the waveguide 210. A second set of reflective facets 318 (one labeled for clarity) at the exit pupil expander 316 receives the incoupled light 320 and reflects the light such that the light is expanded in a second direction 322 towards the outcoupler 214. A third set of reflective facets 314 (one labeled for clarity) at the outcoupler 214 reflects the light received from the exit pupil expander 316 such that the light is outcoupled of the waveguide 210. As described further herein, in some embodiments, the reflective facets overlap with other adjacent reflective facets in the corresponding set of reflective facets so as to eliminate gaps in the light that is reflected from the respective optical component (e.g., from the outcoupler 214).

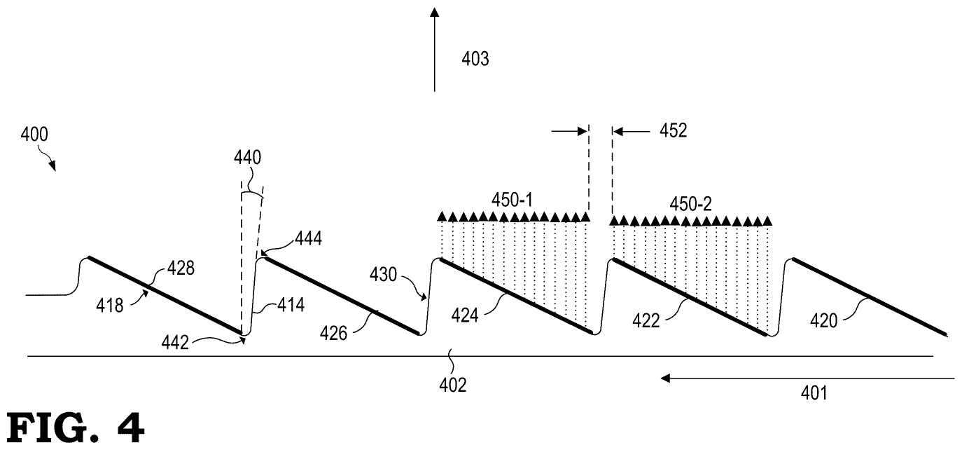

FIG. 4 shows a cross-section view 400 illustrating a set of conventional reflective facets 420-428 in a waveguide (not shown for clarity) and associated problems. When implemented in the waveguide as an outcoupler, for example, the set of conventional reflective facets 420-428 receives light from an exit pupil expander coming from a first direction indicated by arrow 401 and redirects the light out of the waveguide to the user in a second direction indicated by arrow 403.

Generally, the substrate 402 is manufactured by a molding process and is made of a plastic or polymer material that is at least partially transparent. The molded substrate 402 includes a plurality of planar faces 418 (one labeled for clarity). The molded substrate 402 also includes a plurality of secondary planar surfaces 430 (one labeled for clarity). The set of conventional reflective facets 420-428 is formed by applying a reflective coating to the plurality of planar faces 418. Ideally, the plurality of planar faces 418 of the substrate 402 have sharp corners and the secondary planar surfaces are vertical so that there are no gaps between adjacent ones of the reflective facets. In reality, the molded plastic substrates such as substrate 402 do not meet this ideal shape and instead include rounded tips 444 (one labeled for clarity) and rounded roots 442 (one labeled for clarity). In addition, the secondary planar surfaces 430 of molded plastic substrates such as substrate 402 are not vertical and impart draft angles 440 (one labeled for clarity) between the root 442 of one conventional reflective facet 428 and the tip 444 of an adjacent conventional reflective facet 426. The combination of the rounded edges (i.e., roots 442 and tips 442) and the draft angles 440 result in gaps between adjacent ones of the conventional reflective facets 420-428, which in turn create gaps in the light that is reflected by the set of conventional reflective facets 420-428. For example, referring to conventional reflective facets 422 and 424, there is a gap 452 between the light 450-1 reflected by conventional facet 424 and the light 450-2 reflected by conventional facet 422. These gaps 452 result in discontinuities in the virtual image that is delivered to the user, therefore resulting in diminished optical performance.

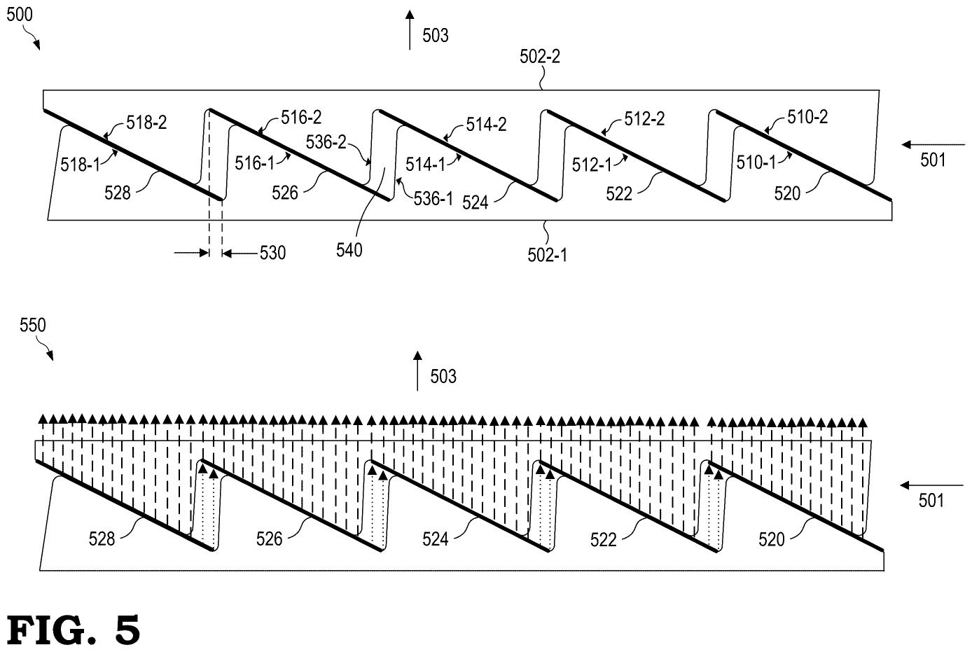

FIG. 5 shows an example cross-section view 500 of a set of overlapping reflective facets 520-528 to be implemented as an outcoupler of a waveguide (not shown for clarity) in accordance with various embodiments. In some embodiments, the set of overlapping reflective facets 520-528 is included in a waveguide (such as waveguide 210 in FIGS. 2 and 3) to implement one or more of an incoupler, exit pupil expander, or an outcoupler. For example, if implemented as part of the outcoupler (e.g., such as outcoupler 214 in the previous figures), the set of reflective facets 520-528 is positioned in the waveguide to receive light from an exit pupil expander coming from a direction indicated by arrow 501 and reflect the light so that it is redirected out of the waveguide in another direction (referred to as the “outcoupling direction”) indicated by arrow 503. As illustrated, the series of reflective facets 520-528 (also referred to as the plurality of reflective facets) are arranged in a series (e.g., one after another) along the direction indicated by arrow 503 in the waveguide.

As shown in cross-section view 500, the set of reflective facets 520-528 includes overlap regions 530 (one labeled for clarity) between adjacent ones of the reflective facets 520-528. That is, the set of reflective facets 520-528 are positioned in a series along a first direction (e.g., corresponding to arrow 501) and adjacent reflective facets of the set of reflective facets overlap with one another along the first direction. In some embodiments, as illustrated, each of the reflective facets 520-528 are oriented to be parallel or substantially parallel to one another. For example, referring to reflective facets 526 and 528, the bottom (also referred to as the tailing portion or the root) of reflective facet 528 overlaps with the top (also referred to as the leading portion or the tip) of reflective facet 526 in the outcoupling direction 503 as indicated by overlap region 530. That is, when viewed from a perspective in the direction of arrow 503, the footprint of reflective facet 526 and the footprint of reflect facet 528 coincide with one another over an area indicated by overlap region 530. The overlap regions 530 between adjacent ones of the reflective facets 520-528 eliminate the aforementioned gaps of light produced by conventional reflective facets (e.g., as shown in FIG. 4), thereby eliminating discontinuities in the outcoupled light and improving the quality of the image delivered by the waveguide. In some embodiments, the overlap region 530 is up to about 500 μm, or up to about 250 μm in other embodiments. For example, in some configurations, the overlap region 530 is minimized (i.e., designed to approach zero) since increasing the amount of overlap may also result in an increase in the thickness of the waveguide.

To illustrate, in some embodiments, the plurality of overlapping reflective facets 520-528 is produced by applying a reflective coating to a first plurality of planar faces 510-1, 512-1, 514-1, 516-1, 518-1 on a first substrate 502-1 and to a second plurality of planar faces 510-2, 512-2, 514-2, 516-2, 518-2 on a second substrate 502-2. Each of the first plurality of planar faces 510-1, 512-1, 514-1, 516-1, 518-1 are oriented parallel or substantially parallel to one another. In some embodiments, the reflective coating is a metallic coating, a dichroic coating, a dielectric coating, a holographic coating, a partially reflective/transmissive coating, or the like. In some embodiments, the secondary reflective facets 536-1 (one labeled for clarity) on the first substrate 502-1 and the secondary reflective facets 536-2 (one labeled for clarity) on the second substrate 502-2 are also at least partially covered in the reflective coating. The first substrate 502-1 and the second substrate 502-2 are positioned such that corresponding ones of the plurality of reflective facets coated with the reflective coating face one another. For example, the first substrate 502-1 is positioned such that one of the first plurality of planar faces 518-1 coated with the reflective coating is in contact with one of the second plurality of planar faces 518-2 coated with the reflective coating of the second substrate 502-2. As shown, the first substrate 502-1 and the second substrate 502-2 are positioned such that there is an offset with respect to the other substrate such that a portion of a primary facet on the first substrate 502-1 protrudes past the corresponding primary facet on the second substrate 502-2 and a portion of the corresponding primary facet on the second substrate 502-2 protrudes past the primary facet on the first substrate 502-1. This offset creates the overlap region 530 (one labeled for clarity) between adjacent ones of the reflective facets 520-528. In addition, this offset creates gaps 540 (one labeled for clarity) between the secondary planar surfaces 536-1 (one labeled for clarity) of the first substrate 502-1 and the secondary planar surfaces 536-2 (one labeled for clarity) of the second substrate 502-2. That is, for example, a secondary planar surface 536-2 of the second substrate 502-2 is not positioned flush with the secondary planar surface 536-1 of the first substrate 502-1 so as to create a gap 540 between the first substrate 502-1 and the second substrate 502-2. In some embodiments, the gaps 540 are filled with an adhesive or polymer material. The adhesive or polymer material helps to secure the first substrate 502-1 to the second substrate 502-2. In addition, the adhesive or polymer material has a refractive index that is matched to the refractive index of the material forming the first substrate 502-1 and the second substrate 502-2. For example, in some embodiments, the first substrate 502-1, the second substrate 502-2, and the adhesive or polymer material filling the gaps 540 all have the same, or substantially the same (e.g., within 5%), refractive index.

FIG. 5 also shows an additional cross-section view 550 of the set of overlapping reflective facets 520-528 reflecting light in the direction indicated by arrow 503. As illustrated, the overlapping reflective facets 520-528 eliminate gaps in the light reflected from adjacent reflective facets of conventional reflective facet configurations such as the gaps 452 shown in FIG. 4. By eliminating the gaps of light reflected from adjacent reflective facets, the waveguide (e.g., such as waveguide 210 in the previous figures) with the overlapping reflective facets 520-528 reduces discontinuities (i.e., gaps) in the outcoupled light. This improves the quality of the virtual image provided to the user.

In some embodiments, the first substrate 502-1 and the second substrate 502-2 are positioned so as to reduce the area of the overlap regions 530. In this manner, the light reflected from a bottom portion of one reflective facet (e.g., from the bottom of reflective facet 522) that is blocked by the top portion of an adjacent reflective facet (e.g., from the top of reflective facet 520) is minimized. FIG. 5 shows five overlapping reflective facets 520-528. In other embodiments, the number of overlapping reflective facets is a number other than five.

In the above embodiment described with respect to FIG. 5, the series of reflective facets are discussed as being planar. In other embodiments, the series of reflective facets are non-planar (i.e., curved). Additionally, in some embodiments, the top and bottom reflective surfaces of the reflective facets vary in terms of wavelength sensitivity, amount of reflectivity, polarization sensitivity, or the like. Similarly, in some embodiments, the wavelength sensitivity, amount of reflectivity, polarization sensitivity, or the like vary across the face of a given reflective facet.

Additionally, in some embodiments of the overlapping reflective facet configuration shown in FIG. 5, there may be (at least to some extent) a reduced brightness of the light reflected from the reflective facets in the overlapping region 530 compared to light reflected from the non-overlapping region. However, any such reduction in brightness (e.g., from 100% to 50%, or even from 100% to 25%) in the overlapping region 530 is still advantageous compared to the total drop off in brightness (i.e., from 100% to 0%) produced by the gaps of the conventional configuration described in FIG. 4.

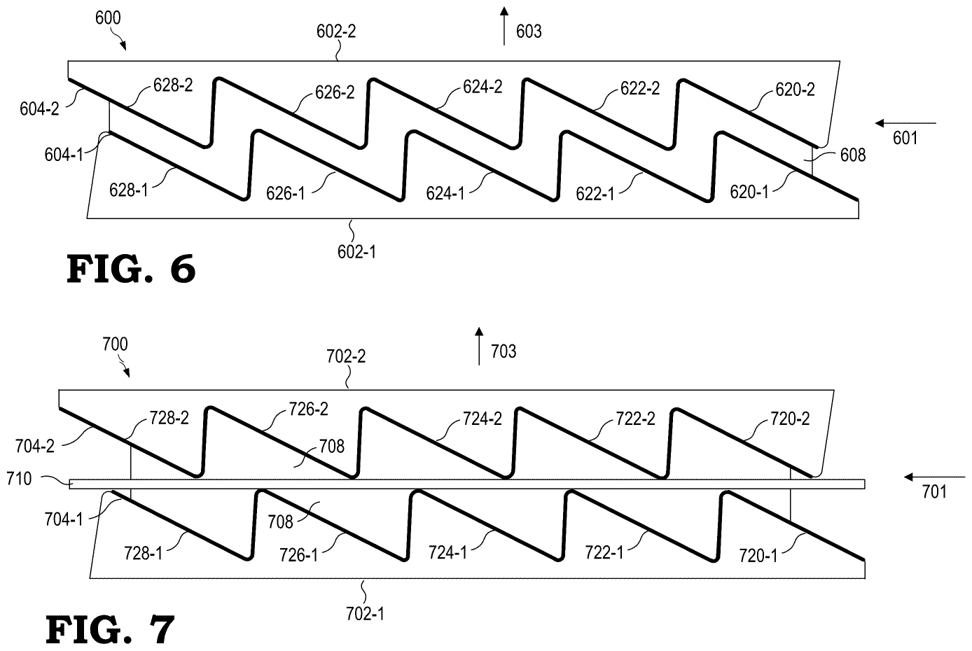

FIGS. 6 and 7 illustrate examples of alternative embodiments of overlapping reflective facets to be implemented at one or more of an incoupler, exit pupil expander, or an outcoupler of a waveguide in accordance with various embodiments. In some aspects, the alternative embodiments shown in FIGS. 6 and 7 facilitate film processing which enables thinner substrates with smaller reflective facets.

FIG. 6 shows an example cross-section view 600 of overlapping sets of reflective facets. A first reflective coating film 604-1 is applied to a first substrate 602-1 and a second reflective coating film 604-2 is applied to a second substrate 602-2 to provide a first set of reflective facets 620-1, 622-1, 624-1, 626-1, 628-1 on the first substrate 602-1 and a second set of reflective facets 620-2, 622-2, 624-2, 626-2, 628-2 on the second substrate 602-2. The first set of reflective facets 620-1, 622-1, 624-1, 626-1, 628-1 and the second set of reflective facets 620-2, 622-2, 624-2, 626-2, 628-2 receive light from the direction indicated by arrow 601 and reflects it toward the direction indicated by arrow 603. The second set of reflective facets 620-2, 622-2, 624-2, 626-2, 628-2 overlap with the first set of reflective facets 620-1, 622-1, 624-1, 626-1, 628-1 and fill in the gaps of the light reflected by the first set of reflective facets 620-1, 622-1, 624-1, 626-1, 628-1.

In some embodiments, the first reflective coating film 604-1 applied to the first substrate 602-1 is different from the second reflective coating film 604-2 applied to the second substrate 602-2. For example, the first reflective coating film 604-1 is a reflective film that reflects red light, and the second reflective coating film 604-2 is a dichroic film that transmits red light and reflects green light.

An adhesive film 608 is provided between the first reflective coating film 604-1 and the second reflective coating film 604-2. In some embodiments, the adhesive film 608 has a refractive index that matches the refractive index of the materials of the first substrate 602-1 and of the second substrate 602-2. For example, the adhesive film 608 has the same refractive index (or substantially the same within 5% or less) as the refractive index of the materials of the first substrate 602-1 and of the second substrate 602-2.

FIG. 7 shows an example cross-section view 700 of overlapping sets of reflective facets. A first reflective coating film 704-1 is applied to a first substrate 702-1 and a second reflective coating film 704-2 is applied to a second substrate 702-2 to provide a first set of reflective facets 720-1, 722-1, 724-1, 726-1, 728-1 on the first substrate 702-1 and a second set of reflective facets 720-2, 722-2, 724-2, 726-2, 728-2 on the second substrate 702-2. The first set of reflective facets 720-1, 722-1, 724-1, 726-1, 728-1 and the second set of reflective facets 720-2, 722-2, 724-2, 726-2, 728-2 receive light from the direction indicated by arrow 701 and reflects it toward the direction indicated by arrow 703. The second set of reflective facets 720-2, 722-2, 724-2, 726-2, 728-2 overlap with the first set of reflective facets 720-1, 722-1, 724-1, 726-1, 728-1 and fill in the gaps of the light reflected by the first set of reflective facets 720-1, 722-1, 724-1, 726-1, 728-1.

In some embodiments, the first reflective coating film 704-1 applied to the first substrate 702-1 is different from the second reflective coating film 704-2 applied to the second substrate 702-2. For example, the first reflective coating film 704-1 is a reflective film that reflects red light, and the second reflective coating film 704-2 is a dichroic film that transmits red light and reflects green light.

An adhesive film 708 and an intermediate film 710 is provided between the first reflective coating film 704-1 and the second reflective coating film 704-2. In some embodiments, the adhesive film 708 and the intermediate film 710 have a refractive index that matches the refractive index of the materials of the first substrate 702-1 and of the second substrate 702-2. For example, the adhesive film 708 and the intermediate film 710 have the same refractive index (or substantially the same within 5% or less) as the refractive index of the materials of the first substrate 702-1 and of the second substrate 702-2. For example, the adhesive film 708 and the intermediate film 710 include a material such as polycarbonate, polymethyl methacrylate (PMMA, or acrylic), or the like. In some embodiments, the intermediate film 710 minimizes the thickness of the adhesive film 708. For example, the intermediate film 710 is made of the same material as the first substrate 702-1 and the second substrate 702-2.

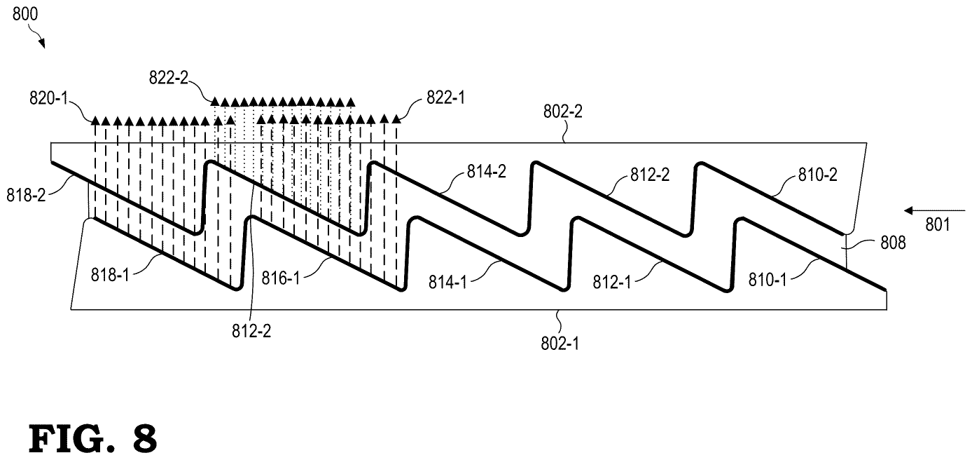

FIG. 8 shows an example cross-section view 800 of an overlapping set of reflective facets corresponding to those shown in FIGS. 7 and 8. An adhesive film 808 is also illustrated between the first substrate 802-1 and the second substrate 802-2. As shown, the second set of reflective facets 810-2, 812-2, 814-2, 818-2 (the label for the fourth reflective facet is omitted for clarity) of the second substrate 802-2 fill in the gaps in the light reflected from the first set of reflective facets 810-1, 812-1, 814-1, 816-1, 818-1 of the first substrate 802-1. For example, the reflective facet of the second set of reflective facets between facet 814-2 and 818-2 (not labeled for clarity) reflects light 822-2 to fill in the gap between the light 822-1 reflected from reflective facet 816-1 and light 820-1 reflected from reflective facet 818-1. As in the previous figures, light is received from the direction indicated by arrow 801

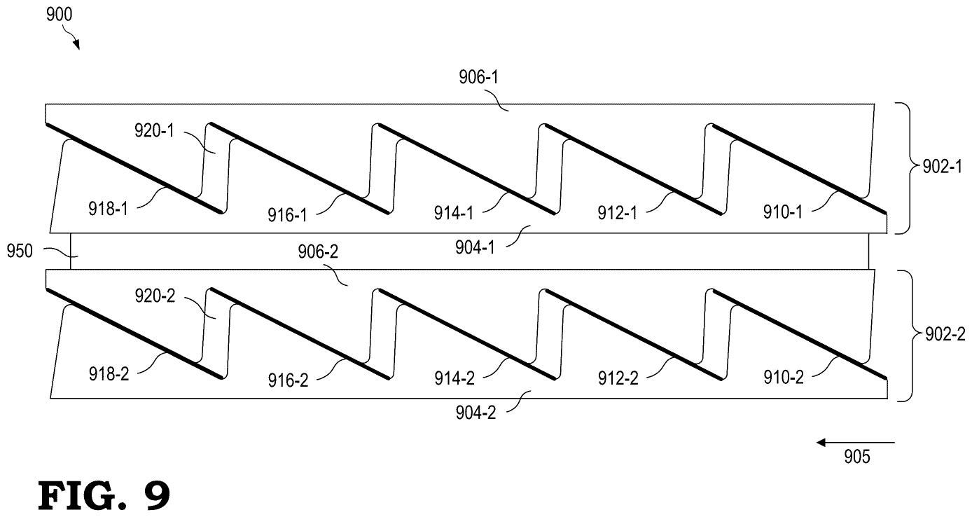

FIG. 9 shows an example cross-section view 900 of a stack of multiple sets of overlapping reflective facets in accordance with various embodiments. For example, the stack includes multiple layers 902-1, 902-2 each implementing a separate set of overlapping reflective facets such as the set of overlapping reflective facets shown in FIG. 5.

A first layer 902-1 includes a first substrate 904-1 and a second substrate 906-1 (e.g., respectively corresponding to substrates 502-1 and 502-2 of FIG. 5) implementing a first set (also referred to as a first plurality) of overlapping reflective facets 910-1, 912-1, 914-1, 916-1, 918-1. As shown, the first set of overlapping reflective facets 910-1, 912-1, 914-1, 916-1, 918-1 are arranged in series adjacent to one another along a first direction 901. Adjacent ones of the first set of overlapping reflective facets 910-1, 912-1, 914-1, 916-1, 918-1 overlap one another along the first direction 901. The gaps 920-1 (one labeled for clarity) created between the first substrate 904-1 and the second substrate 906-1 are filled with an adhesive or polymer material that has a refractive index that matches the refractive index of the material of the first substrate 904-1 and the second substrate 906-1. Thus, the first set of overlapping reflective facets 910-1, 912-1, 914-1, 916-1, 918-1 reflects light having no gaps or discontinuities. In some embodiments, the first set of overlapping reflective facets 910-1, 912-1, 914-1, 916-1, 918-1 is made from a dichroic or other partially reflective material to reflect light of a first wavelength range (e.g., blue and green light) and transmit light of a second wavelength range (e.g., red light).

A second layer 902-2 includes a third substrate 904-2 and a fourth substrate 906-2 (e.g., respectively corresponding to substrates 502-1 and 502-2 of FIG. 5) implementing a second set (also referred to as a second plurality) of overlapping reflective facets 910-2, 912-2, 914-2, 916-2, 918-2. As shown, the second set of overlapping reflective facets 910-2, 912-2, 914-2, 916-2, 918-2 are arranged in series adjacent to one another along the first direction 901 below the first set of overlapping reflective facets 910-1, 912-1, 914-1, 916-1, 918-1. Adjacent ones of the second set of overlapping reflective facets 910-2, 912-2, 914-2, 916-2, 918-2 overlap one another along the first direction 901. The gaps 920-2 (one labeled for clarity) created between the third substrate 904-2 and the fourth substrate 906-2 are filled with an adhesive or polymer material that has a refractive index that matches the refractive index of the material of the third substrate 904-2 and the fourth substrate 906-2. Thus, the second set of overlapping reflective facets 910-2, 912-2, 914-2, 916-2, 918-2 reflects light having no gaps or discontinuities. In some embodiments, the second set of overlapping reflective facets 910-2, 912-2, 914-2, 916-2, 918-2 is made from a dichroic or other partially reflective material to reflect light of the second wavelength range (e.g., red light) that is transmitted by the first set of overlapping reflective facets 910-1, 912-1, 914-1, 916-1, 918-1. In this manner, each set of reflective facets can be designed to reflect a particular wavelength range of light to increase the overall amount of light that is reflected from the stack of multiple sets of overlapping reflective facets.

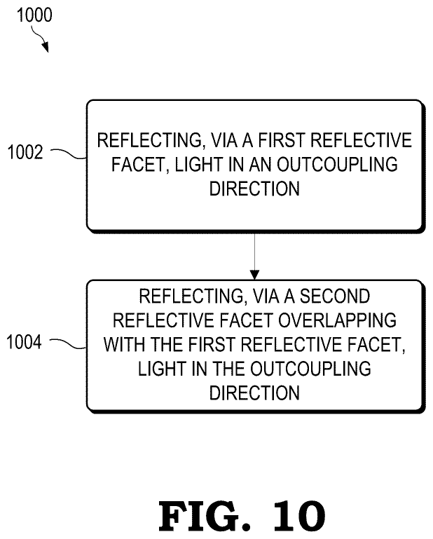

FIG. 10 shows a flowchart 1000 describing a method for reflecting light from a set of overlapping reflective facets in accordance with various embodiments. For example, the set of overlapping reflective facets is implemented as an outcoupler of a waveguide illustrated or described in one of the previous figures. At 1002, the method includes reflecting, via a first reflective facet in the set of overlapping reflective facets, light in an outcoupling direction. For example, the outcoupling direction is toward a user wearing an eyewear display such as the eyewear display of FIG. 1. At 1004, the method includes reflecting, via a second reflective facet overlapping with the first reflective facet, light in the outcoupling direction.

In some embodiments, the techniques provided herein eliminate the gaps between reflective facets as seen in conventional reflective facet waveguides. Therefore, the techniques provided herein provide reflective facet waveguide that delivers a more uniform and higher quality virtual image. In some embodiments, the techniques provided herein allow for the molding of shorter reflective facets in each substrate to facilitate the processing of the corresponding substrates. Additionally, the techniques described herein allow for thinner substrates, thereby allowing the stacking of multiple substrates together (e.g., as shown in FIG. 9) within an allowable form factor (e.g., within the thickness of a lens of an eyewear display).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A waveguide comprising:
a plurality of reflective facets arranged along a first direction in the waveguide,
wherein adjacent reflective facets of the plurality of reflective facets overlap one another along the first direction.

2. The waveguide of claim 1, further comprising two substrates, a first substrate of the two substrates comprising a first plurality of planar faces, and a second substrate of the two substrates comprising a second plurality of planar faces.

3. The waveguide of claim 2, further comprising a reflective coating on the first plurality of planar faces and on the second plurality of planar faces.

4. The waveguide of claim 3, wherein the first plurality of planar faces coated with the reflective coating is positioned to contact the second plurality of planar faces coated with the reflective coating.

5. The waveguide of claim 4, wherein each of the plurality of reflective facets are formed at an interface between the first plurality of planar faces with the reflective coating and the second plurality of planar faces with the reflective coating.

6. The waveguide of claim 2, further comprising a gap between the first substrate and the second substrate, wherein the gap is filled with an adhesive material to adhere the first substrate to the second substrate.

7. The waveguide of claim 6, wherein the adhesive material comprises a refractive index corresponding to a refractive index of a material of the first substrate and the second substrate.

8. The waveguide of claim 7, wherein the refractive index of the adhesive material is matched to the refractive index of the material of the first substrate and the second substrate.

9. The waveguide of claim 2, further comprising a second plurality of reflective facets arranged in series along the first direction in the waveguide, the second plurality of reflective facets adjacent to the plurality of reflective facets, wherein adjacent reflective facets of the second plurality of reflective facets overlap one another along the first direction.

10. The waveguide of claim 9, further comprising a third substrate and a fourth substrate, the third substrate comprising a third plurality of planar faces, and the fourth substrate comprising a fourth plurality of planar faces.

11. The waveguide of claim 10, further comprising a second reflective coating on the third plurality of planar faces and on the fourth plurality of planar faces, the second reflective coating different than a reflective coating on the first plurality of planar faces and on the second plurality of planar faces.

12. The waveguide of claim 11, wherein the third plurality of planar faces coated with the second reflective coating is positioned to contact the fourth plurality of planar faces coated with the second reflective coating.

13. The waveguide of claim 12, wherein each of the second plurality of reflective facets are formed at an interface between the third plurality of planar faces with the second reflective coating and the fourth plurality of planar faces with the second reflective coating.

14. The waveguide of claim 10, further comprising a gap between the third substrate and the fourth substrate, wherein the gap between the third substrate and the fourth substrate is filled with an adhesive material to adhere the third substrate to the fourth substrate, wherein the adhesive material to adhere the third substrate to the fourth substrate comprises a refractive index corresponding to a refractive index of a material of the third substrate and the fourth substrate.

15. The waveguide of claim 14, wherein adhesive material to adhere the third substrate to the fourth substrate is a same material as the adhesive material to adhere the first substrate to the second substrate, wherein an additional layer of adhesive material adheres the first substrate or the second substrate to the third substrate or the fourth substrate.

16. A waveguide comprising:
a first plurality of reflective facets arranged along a first direction in the waveguide, wherein adjacent reflective facets of the first plurality of reflective facets overlap one another along the first direction; and
a second plurality of reflective facets arranged along the first direction in the waveguide, wherein adjacent reflective facets of the second plurality of reflective facets overlap one another along the first direction.

17. The waveguide of claim 16, wherein the first plurality of reflective facets is configured to reflect a first wavelength range of light and transmit a second wavelength range of light.

18. The waveguide of claim 17, wherein the second plurality of reflective facets is configured to reflect the second wavelength range of light, and light reflected from the second plurality of reflective facets passes through the first plurality of reflective facets.

19. A method comprising:
reflecting, via a first reflective facet in a plurality of reflective facets at an outcoupler of a waveguide, light in an outcoupling direction; and
reflecting, via a second reflective facet in the plurality of reflective facets at the outcoupler, light in the outcoupling direction, wherein a portion of the light reflected from the second reflective facet coincides with a portion of the light reflected from the first reflective facet.

20. The method of claim 19, wherein the plurality of reflective facets is arranged in a series along a first direction in the waveguide, wherein adjacent reflective facets of the plurality of reflective facets overlap one another along the first direction.
